(19) United States
(12) Patent Application Publication
(10) Pub. No.: US 2016/0359354 A1
(43) Pub. Date: Dec. 8, 2016

(54) Self-reliant fuel-less power generator

(71) Applicant: Regnault Umaru Bamiji, Jos (NG)

(72) Inventor: Regnault Umaru Bamiji, Jos (NG)

(21) Appl. No.: 14/732,762

(22) Filed: Jun. 7, 2015

(51) Int. Cl. H02J 7/02; H02J 7/00; H02J 7/04

(52) U.S. Cl. CPC H02J 7/022; H02J 7/045; H02J 7/0045; H02J 7/345

(57) ABSTRACT

A self-reliant fuel-less power generator includes a Ultra capacitor module 4, which supplies instant charging and stabilizing voltage to a deep cycle battery 3 which in turn supplies the inverter 2 with continuous dc voltage supply, a battery charger is connected from the inverter 2 to the Ultra capacitor module 4 to continuously charge the Ultra capacitor module 4, supplying instant and continuous voltage to the deep cycle battery 3 and the inverter 2, if the Self reliant fuel less generator is not operated for three days, the Ultra capacitor modules 4, needs to be activated by connecting a deep cycle battery to the DC charge activator inlet socket 9 or external battery charger to the AC charge activator inlet socket 8, which fully charge the Ultra capacitor module in ten minutes to start the generator.

This invention relates to power generation using an inverter without the need of external source, such as solar, wind, hydro-power or any form of fossil fuel to provide electricity. It is self-reliant fuel less power generator which supplies the AC voltage for domestic use and also generating and storing DC voltage which will be converted to AC voltage for further use when the system is generation electricity.

The purpose of the invention is to solve the problem people face with the use of inverter for domestic power supply. Inverters need batteries and the batteries needs to be charged with solar power, wind turbine, or using battery chargers that require domestic power supply to charge the batteries. Solar and wind are not readily available and in areas where there is no electricity, the batteries cannot be charged, while in most areas where electricity is available users have to wait for several hours to charge the batteries before using it with the inverter. The operational system of the Self Reliant fuel less generator solve the problem of waiting for too long for inverter batteries to get fully charge before using the inverter.

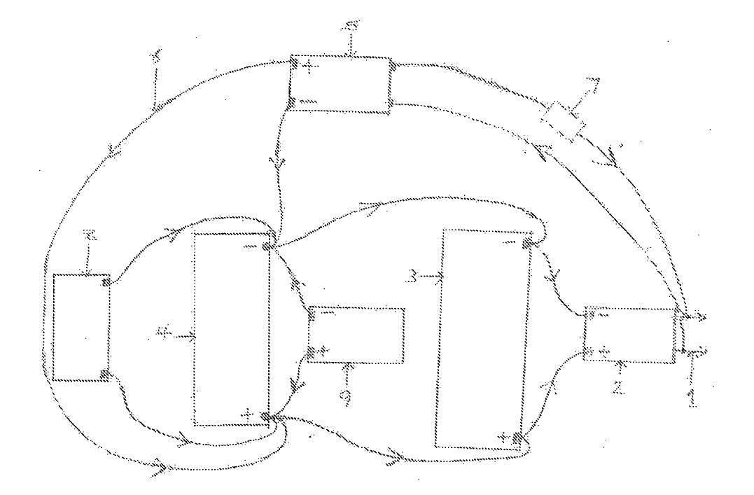

This invention solves the problem of using the inverter without the use of solar, wind, fuel cells, hydro power to charge the batteries. FIG. 1 below shows an Ultra Capacitor module 4, Deep cycle battery 3, Battery charger 5, fuse 7, DC voltage inverter 2, AC Charge activator socket inlet 8, DC Charge activator socket inlet 9.

When the DC voltage inverter 2, is switch ON, it supplies 230 Vac to the home 1, part of the home supply is connected to the battery charger 5, the charger is then connected to the ultra capacitor module 4 to charge it within 10 minutes, the ultra capacitor module 4 which is connected to the deep cycle battery 3, discharge its voltage to the deep cycle battery 3, until both voltages are equal, finally supplying the inverter 2 with stable dc voltage. The ultra capacitor module 4 acts as instant charger to the deep cycle battery 3, and a stabilizing voltage for the inverter 2. The battery charger 5 is continuously charging the ultra capacitor modules 4 to maintain voltage equilibrium between the ultra capacitor module 4 and the deep cycle battery 3.

When the Self reliant fuel less power generator, has not been operated for more than three days, the voltages of both the Ultra capacitor 4 and the deep cycle battery 3, drops, and the system may not start when next is needed to be operated.

There are two options to activate the system, that is, to charge the Ultra capacitor module 4, Option one, is to connect an external battery charger to the Self reliant fuel less power generator via the AC charge activator inlet socket 8 to charge the ultra Capacitor module 4 in ten minutes, which in turn instantly supply voltage to the deep cycle battery 3, to start the system. Option two, is to connect a deep cycle battery to the DC charge activator inlet socket 9 for ten minutes, this also charge the ultra capacitor module 4 in ten minutes which in turn instantly discharges its voltage to the deep cycle battery 3, ready to start the system.
To home supply 1
Inverter 2
Deep Cycle battery 3
Ultra Capacitor Module 4
Battery Charger 5
Connecting Cables 6
Fuse 7
AC Charger Activator inlet Socket 8
DC Charger Activator Outlet Socket 9

1. A Self Reliant fuel-less power generator comprising of an DC voltage inverter 2, Ultra capacitor module 4, deep cycle battery 3, fuse 7, battery charger 5, AC charge activator inlet socket 8, DC charge activator inlet socket 9, to supply electricity without waiting hours for batteries to fully charge first for use with inverters, the AC charge activator inlet socket 8 and DC charge activator inlet socket 9, is use to externally activate the system when the system has not been used for three days upward.

2. A Self Reliant fuel-less power generator according to claim 1, which uses a Ultra capacitor module 4, to supply instant voltage charge to the deep cycle battery 3, keeping the voltage stabilized as it supplies the inverter 2 with a DC voltage continuously.

3. A Self Reliant fuel-less generator according to claim 2, that uses a battery charger 5, connected from the inverter 2 supply line to charge the Ultra capacitor module 4, in ten minutes, and in turn supplies instant voltage charge to the deep cycle battery 3, keeping the deep cycle battery 3 and Ultra capacitor module 4, voltages stabilized in operation, without depletion in dc supply voltage to the inverter.
